(19) United States
(12) Patent Application Publication
(10) Pub. No.: US 2021/0152031 A1
(43) Pub. Date: May 20, 2021

(54) POWER TRANSMISSION DEVICE, POWER RECEPTION DEVICE, POWER TRANSMISSION SYSTEM, POWER TRANSMISSION METHOD, POWER RECEPTION METHOD, AND NON-TRANSITORY RECORDING MEDIUM

(71) Applicant: SHARP KABUSHIKI KAISHA, Sakai City (JP)

(72) Inventor: HIROKAZU KOBAYASHI, Sakai City (JP)

(21) Appl. No.: 17/096,732

(22) Filed: Nov. 12, 2020

(30) Foreign Application Priority Data
Nov. 14, 2019 (JP) 2019-206186

(51) Int. Cl. H02J 50/60; H02J 50/80; H02J 50/10; H02J 7/02; H02J 7/00

(52) U.S. Cl. CPC H02J 50/60; H02J 50/80; H02J 7/00032; H02J 7/02; H02J 50/10

(57) ABSTRACT

A power transmission device comprises a power supply that transmits power to a power reception device, a transmission-efficiency acquirer that acquires transmission efficiency information indicating a transmission efficiency of the power transmitted to the power reception device, a communicator that receives hold information indicating whether or not the power reception device is held by a user from the power reception device, when the transmission efficiency information indicates that the transmission efficiency changed and a power controller that continues the power transmission performed by the power supply when the hold information received by the communicator indicates that the power reception device is held by the user and that stops the power transmission performed by the power supply when the hold information indicates that the power reception device is not held by the user.

### BACKGROUND

### 1. Field

The present disclosure relates to a power transmission device, a power reception device, a power transmission system, a power transmission method, a power reception method, and a non-transitory recording medium.

### 2. Description of the Related Art

Heretofore, wireless chargers have been known that detect foreign objects thereon. For example, Japanese Patent No. 5713874 discloses a wireless charger that is characterized in that a battery in equipment to be charged. is charged by an induced electromotive force due to mutual inductance and that includes a primary coil, a position detector, an initial-position adjuster, a charging-power controller, and a foreign-object detector. The foreign-object detector includes coil controlling means, efficiency measuring means, and determining means.

Specifically, the wireless charger described above is a wireless charger that uses an induced electromotive force to charge equipment to be charged and includes: a primary coil that transmits induced current to a secondary coil in the equipment to be charged; a position detector that detects the position of the secondary coil; an initial-position adjuster that adjusts the position of the primary coil to a position (an initial position) where an axial center of the primary coil and an axial center of the secondary coil match each other; a coil controlling means that sequentially moves the primary coil to measurement positions at a predetermined distance away from the initial position and in respective two or more measurement directions with respect to the initial position, the measurement directions being within a plane that is orthogonal to the axial center of the primary coil; an efficiency measuring means that measures charging efficiencies of the equipment to be charged for the respective measurement positions; and a determining means that transmits a charging-stop instruction when a difference between the charging efficiency at one of the measurement positions in one of the measurement directions and the charging efficiency at the measurement position that is the same distance away from the initial position in another measurement direction is larger than or equal to a predetermined threshold.

### SUMMARY OF THE INVENTION

However, related art as described above has a problem in that charging is also stopped by a charging efficiency change due to a cause other than the presence of a metal foreign object.

It is desirable to suppress power transmission stop caused by foreign-object false detection r the like.

According to one aspect of the disclosure, there is provided a power transmission device including: a power supply that transmits power to a power reception device; a transmission-efficiency acquirer that acquires transmission efficiency information indicating a transmission efficiency of the power transmitted to the power reception device; a communicator that receives hold information indicating whether or not the power reception device is held by a user from the power reception device, when the transmission efficiency information indicates that the transmission efficiency changed; and a power controller that continues the power transmission performed by the power supply when the hold information received by the communicator indicates that the power reception device is held by the user and that stops the power transmission performed by the power supply when the hold information indicates that the power reception device is not held by the user.

According to one aspect of the disclosure, there is provided a power reception device including: a power receiver that receives power transmitted from a power transmission device; a user-operation detector that detects whether or not the power reception device is held by a user when the power receiver receives the power; and a communicator that transmits, to the power transmission device, hold information indicating a result of the detection performed by the user-operation detector.

According to one aspect of the disclosure, there is provided a power transmission system including a power transmission device and a power reception device. The power transmission system includes: a transmission-efficiency acquirer that acquires transmission efficiency information indicating a transmission efficiency of power transmitted from the power transmission device to the power reception device; a user-operation acquirer that acquires hold information indicating whether or not the power reception. device is held by a user, when the transmission efficiency information indicates that the transmission efficiency changed; and a power controller that continues the power transmission performed by the power transmission device when the hold information acquired by the user-operation acquirer indicates that the power reception device is held by the user and that stops the power transmission performed by the power transmission device when the hold information indicates that the power reception device is not held by the user.

According to one aspect of the disclosure, there is provided a power transmission method including: transmitting power to a power reception device; acquiring transmission efficiency information indicating a transmission efficiency of the power transmitted to the power reception device; receiving hold information indicating whether or not the power reception device is held by a user from the power reception device, when the transmission efficiency information indicates that the transmission efficiency changed; and continuing the power transmission when the received hold information indicates that the power reception device is held by the user and stopping the power transmission when the hold information indicates that the power reception device is not held by the user.

According to one aspect of the disclosure, there is provided a power reception method including: receiving power transmitted from a power transmission device; detecting whether or not the power reception device is held by a user when the power is received; and transmitting hold information indicating a result of the detection to the power transmission device.

### BRIEF DESCRIPTION OF THE DRAWINGS

FIG. 1 is a block diagram illustrating the configuration of major portions in a power transmission system according to an embodiment of the present disclosure;

FIG. 2 is a view schematically illustrating the power transmission system illustrated in FIG. 1;

FIG. 3 is a flowchart illustrating power transmission processing performed by a power transmission device in the power transmission system illustrated in FIG. 1;

FIG. 4 is a flowchart illustrating power reception processing performed by a power reception device in the power transmission system illustrated in FIG. 1; and.

FIG. 5 illustrates a communication protocol between the power transmission device and the power reception device in the power transmission system illustrated in FIG. 1.

### DETAILED DESCRIPTION OF THE INVENTION

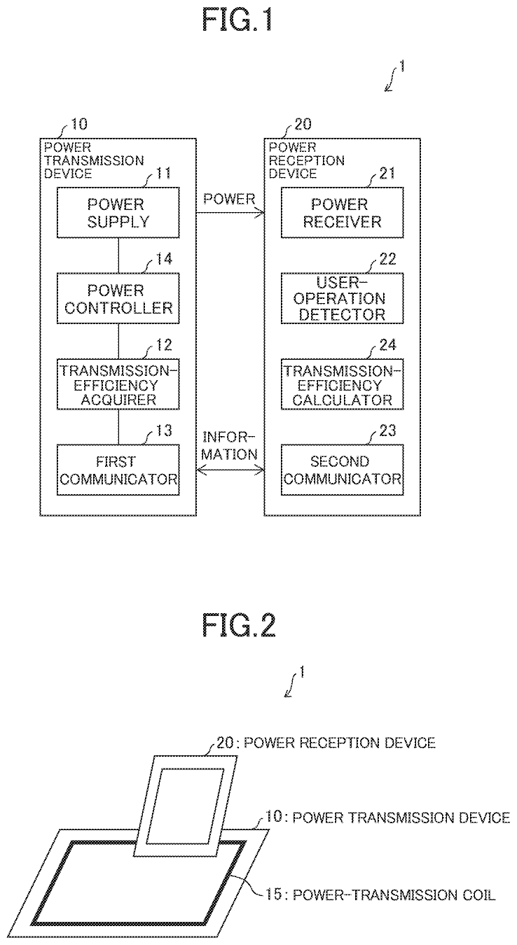

One embodiment of the present disclosure will be described in detail with reference to FIGS. 1 to 5.

### (Power Transmission System 1)

FIG. 1 is a block diagram illustrating the configuration of major portions in a power transmission system 1 according to the present embodiment. As illustrated in FIG. 1, the power transmission system 1 includes a power transmission device 10 and a power reception device 20. The power transmission device 10 is a wireless charger for charging the power reception device 20.

The power reception device 20 is, for example, a smartphone, but is not limited thereto in the present embodiment. For example, the power reception device 20 may be a tablet computer, a video game console, wearable equipment, or the like.

### (Power Transmission Device 10)

As illustrated in FIG. 1, the power transmission device 10 includes a power supply 11, a transmission-efficiency acquirer 12, a first communicator 13 (a communicator; a power-transmission-device-side communicator), and a power controller 14. Although not particularly illustrated, the power transmission device 10 includes a power-reception-device detector that detects whether or not the power reception device 20 is placed an the power transmission device 10.

The power supply 11 transmits power to the power reception device 20. For example, the power supply 11 may include a power transmission coil 15 illustrated in FIG. 2.

The transmission-efficiency acquirer 12 acquires transmission efficiency information indicating a transmission efficiency of power transmitted to the power reception device 20. The transmission efficiency is calculated, for example, according to equation:

“Transmission Efficiency”=“Power Received by Power Reception Device”/“Power Transmitted by Power Transmission Device”×100% (1)

One example of the transmission efficiency information indicating the transmission efficiency may be information simply indicating that the transmission efficiency changed. Another example of the transmission efficiency information may be information indicating a comparison result of comparison of the transmission efficiency with a predetermined value (e.g., information indicating that the transmission efficiency is larger than or smaller than a predetermined value).

Although a configuration in which the power transmission device 10 receives the transmission efficiency information indicating the transmission efficiency from the power reception device 20 is described in the present embodiment by way of example, the present embodiment is not limited to this configuration. For example, the power transmission device 10 itself may calculate the transmission efficiency.

When the transmission efficiency information acquired by the transmission-efficiency acquirer 12 indicates that the transmission efficiency changed, the first communicator 13 receives hold information indicating whether or not the power reception device 20 is held by the user from the power reception device 20.

Specifically, when the transmission efficiency information indicates that the transmission efficiency changed, the first communicator 13 may transmit, to the power reception device 20, information for requesting transmission of the hold information indicating whether or not the power reception device 20 is held by the user.

When the hold information indicates that the power reception device 20 is held by the user, the power controller 14 causes the power supply 11 to continue the power transmission. On the other hand, when the hold information indicates that the power reception device 20 is not held by the user, the power controller 14 causes the power supply 11 to stop the power transmission.

According to the above-described configuration, the power controller 14 controls whether or not the power supply 11 is to perform power transmission, based on the hold information, and thus it is possible to suppress power transmission stop caused by a transmission efficiency change due to a cause other than the presence of a foreign object, that is, it is possible to suppress charging stop that is unintended by the user. In other words, according to the above-described configuration, it is possible to suppress power transmission stop caused by foreign-object false detection.

### (Power Reception Device 20)

As illustrated in FIG. 1, the power reception device 20 includes a power receiver 21, a user-operation detector 22, a second communicator 23 (a communicator; a power-reception-device-side communicator), and a transmission-efficiency calculator 24. The power reception device 20 includes a chargeable battery, which is not illustrated.

The power receiver 21 receives power transmitted from the power transmission device 10. For example, the power receiver 21 may include a power-reception coil (not illustrated) that receives power via electromagnetic induction performed by the power-transmission coil 15 illustrated in FIG. 2.

The user-operation detector 22 detects whether or not the power reception device 20 is held by the user at least when the power receiver 21 receives power. A method for the detection may be an existing detection method. Examples of the detection method include detecting that a screen (a touch panel) of the power reception device 20 is operated by the user, detecting the presence/absence of pressure on the housing of the power reception device 20 by using a pressure-sensitive sensor (a grip sensor), and. performing sensing by using a proximity sensor that may be additionally included in the power reception device 20.

After the detection, the second communicator 23 transmits, to the power transmission device 10, the hold information indicating a result of the detection performed by the user-operation detector 22.

The transmission-efficiency calculator 24 calculates a transmission efficiency of power transmitted from the power transmission device 10. When the transmission efficiency calculated by the transmission-efficiency calculator 24 changes, the second communicator 23 may transmit, to the power transmission device 10, transmission efficiency information indicating that the transmission efficiency changed.

Although a configuration in which the power reception device 20 calculates the transmission efficiency and transmits the transmission efficiency information to the power transmission device 10, as described above, will be described in the present embodiment, the present disclosure is not limited to this configuration, and for example, the power transmission device 10 itself may calculate the transmission efficiency.

### (Flowchart of Power Transmission Processing)

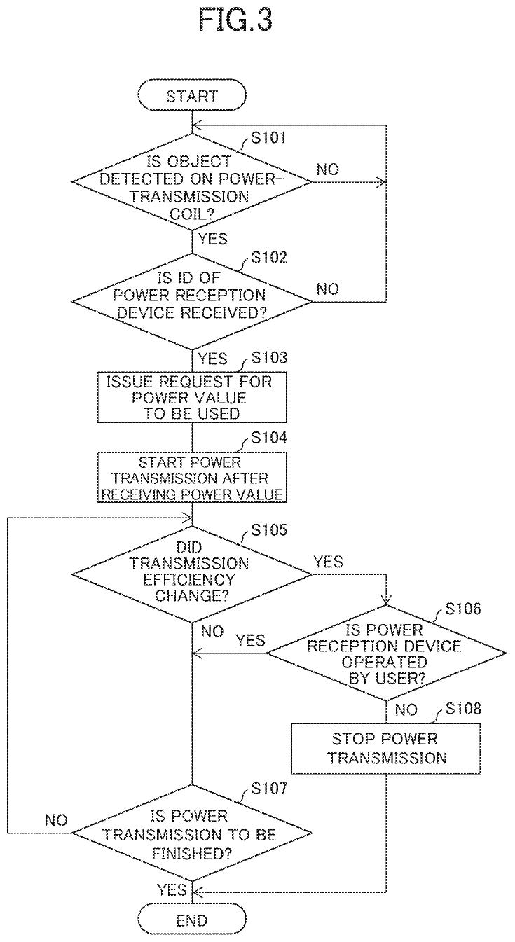

FIG. 3 is a flowchart illustrating power transmission processing performed by the power transmission device 10 in the power transmission system 1 illustrated in FIG. 1. First, in step 5101, for example, the power-reception-device detector built in the power transmission device 10 detects whether or not any object is present on the power-transmission coil 15 (see FIG. 2) in the power transmission device 10.

Next, if the power-reception-device detector detects that an object is present on the power-transmission coil 15 (YES in step S101), the power transmission device 10 attempts to obtain identification (ID) information of: the power reception device 20 via the first communicator 13 in step S102. In other words, the power transmission device 10 transmits, to the power reception device 20, a signal for requesting transmission of ID information. The “ID information” as used herein refers to information for identifying the power reception device 20.

On the other hand, if the power-reception-device detector detects that no object is present on the power-transmission coil 15 (NO in step S101), the process returns to step S101.

Subsequently, if the power transmission device 10 obtains the ID information of the power reception device 20 (YES in step S102), the power transmission device 10 issues a request for a power value to be used to the power reception device 20 via the first communicator 13 in step S103. The power transmission device 10 receives, from the power reception device 20, information indicating a charging state indicating to which degree a battery in the power reception device 20 is charged, in addition to the ID information. On the other hand, if the power transmission device 10 fails to obtain the ID information of the power reception device 20 (NO in step S102), the process returns to step S101.

Subsequently, in step S104, the power supply 11, which is controlled by the power controller 14 the power transmission device 10, starts power transmission in accordance with the power value obtained from the power reception device 20.

In step S105, the power transmission device 10 obtains the transmission efficiency information from the power reception device 20 to determine whether or not the transmission efficiency changed. Upon determining that the transmission efficiency changed (YES in step S105), the process proceeds to step S106 in which the power transmission device 10 obtains, from the power reception device 20, the hold information indicating that the power reception device 20 is held by the user (that is, the power reception device 20 is operated by the user).

When the power transmission device 10 itself calculates the transmission efficiency, in step S105, the power transmission device 10 may determine whether or not the transmission efficiency calculated thereby changed. If the power transmission device 10 determines that the transmission efficiency does change (NO in step S105), the power transmission to the power reception device 20 is continued (the process proceeds to step S107).

If the power transmission device 10 obtains the hold information indicating that the power reception device 20 is held by the user (YES in step S106), the power controller 14 causes the power transmission to be continued (the process proceeds to step S107).

On the other hand, if the power transmission device 10 obtains the hold information indicating that the power reception device 20 is not held by the user (NO in step S106), the power controller 14 causes the power transmission to be stopped (step S108). Thereafter, the processing based on the flowchart in FIG. 3 ends.

In step S107, the power controller 14 refers to information indicating the power reception state of the power reception device 20 to determine whether or not the power transmission is to be finished. In step S107, if the power reception device 20 is fully charged, the power controller 14 causes the power transmission to be stopped.

If the power controller 14 determines that the power transmission is to be finished. (YES in step S107), the power controller 14 causes the power transmission to be finished. On the other hand, if the power controller 14 determines that the power transmission is not to be finished (NO in step S107), the process returns no step S105, and step S105 and the subsequent steps are repeated.

### (Flowchart of Power Reception Processing)

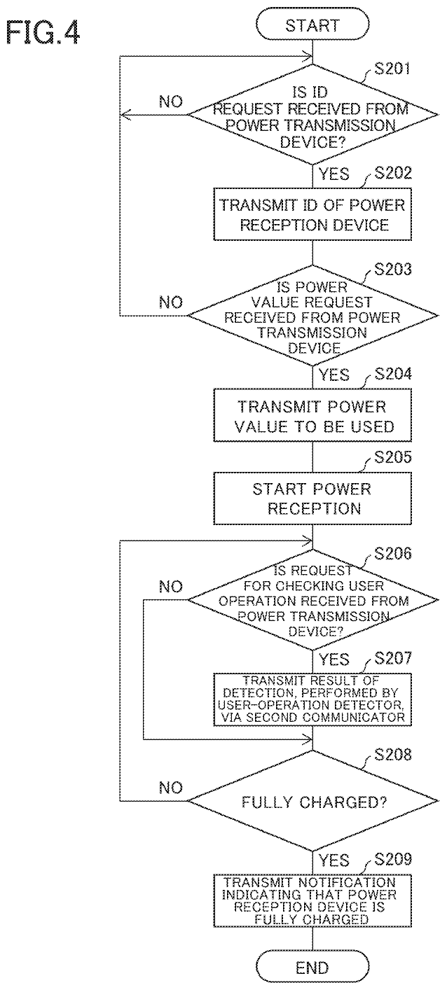

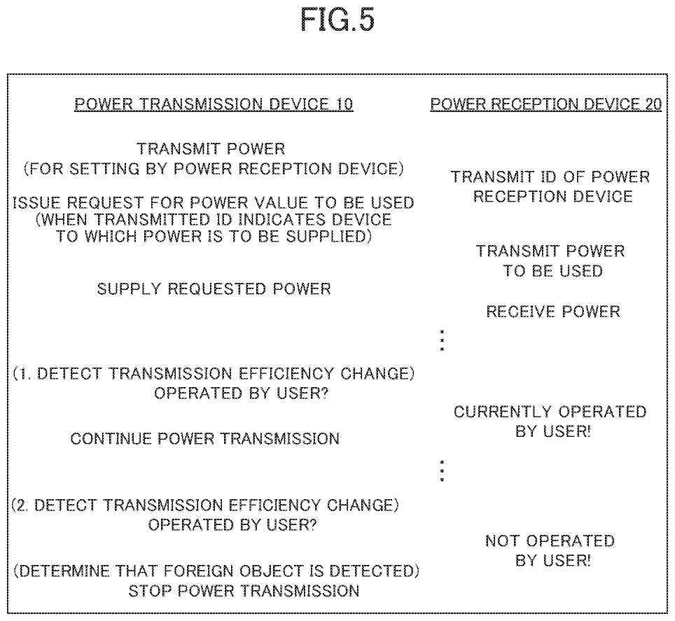

FIG. 4 is a flowchart illustrating power reception processing performed by the power reception device 20 in the power transmission system illustrated in FIG. 1. As illustrated in FIG. 4, first, in step S201, the power reception device 20 determines whether or not a signal for requesting the ID information of the power reception device 20 is received from the power transmission device 10. If it is determined that the signal is received from the power transmission device 10 (YES in step S201), the process proceeds to step S202 in which the power reception device 20 transmits the ID information of the power reception device 20 to the power transmission device 10 via the second communicator 23. The power reception device 20 also transmits, to the power transmission device 10 via the second communicator 23, information indicating a charging state indicating to which degree the battery in the power reception device 20 is charged. If the power reception device 20 determines that the above-described signal is not received, the process for waiting for the signal to be received is continued in step S201.

Subsequently, in step S203, the power reception device 20 determines whether or not a power value request is received from the power transmission device 10. If the power value request is received from the power transmission device 10 (YES in step S203), the process proceeds to step S204 in which the power reception device 20 transmits a power value to be used to the power transmission device 10 via the second communicator 23. On the other hand, if the power value request is not received from the power transmission device 10 (NO in step S203), the process returns to step S201. The case in which the power value request is not received from the power transmission device 10 is, for example, a case in which the battery in the power reception device 20 is fully charged.

Even when the power reception device 20 receives the signal for requesting transmission of the ID information in step S201 when the battery in the power reception device 20 is in a fully charged state in step S201, the process may transition to “NO” to return to S201 without continuing the subsequent power reception processing.

In step S205, the power reception device 20 starts receiving power from the power transmission device 10. Next, in step S206, the power reception device 20 determines whether or not a request for checking whether or not a user operation is performed on the power reception device 20 during the power reception is received from the power transmission device 10.

If the request for checking whether or not a user operation is performed on the power reception device 20 during the power transmission is received (YES in step S206), the process proceeds to step S207 in which the power reception device 20 transmits a result of detection, performed by the user-operation detector 22, to the power transmission device 10 via the second communicator 23. If the power reception device 20 transmits information indicating that the user does not hold the power reception device 20, the power transmission device 10 executes a process in step S108, and thus the processing in the flowchart in FIG. 4 ends before the battery is fully charged. If the request for checking whether or not a user operation is performed on the power reception device 20 during the power transmission is not received (NO in step S206), the power reception device 20 continues the power reception and advances to step S208.

In step S208, a determination is made as to whether or not the power reception device 20 is fully charged (i.e., is in a state in which the amount of power to be used is received). If it is determined that the power reception device 20 is fully charged (YES in step S208), the process proceeds to step S209 in which the second communicator 23 transmits notification to that effect to the power transmission device 10 and ends the power reception processing illustrated in the flowchart. On the other hand, if it is determined that the power reception device 20 is not fully charged. (NO in step S208), the process returns to step S206, and the processes in steps S206 to S208 are repeated.

### (Modification)

Although a configuration in which the processes in the transmission-efficiency acquirer 12 and the power controller 14 are executed by the power transmission device 10 has been described in the above-described embodiment, the processes executed thereby may be executed by the power reception device 20. The power transmission device 10 or the power reception device 20 may also include a user-operation acquirer. The user-operation acquirer performs processing for acquiring the result of the detection performed by the user-operation detector 22 included in the power reception device 20, the result being indicative of whether or not the power reception device 20 is held by the user. When the power transmission device 10 includes the user-operation acquirer, the power transmission device 10 can also use the result of the detection performed by the user-operation detector 22.

Also, in the Power transmission system 1, the processes in the transmission-efficiency acquirer 12, the power controller 14, and the above-described user-operation acquirer may be performed by the power transmission device 10 or may be performed by the power reception device 20.

According to another aspect, the power transmission system in the above-described modification may include: the transmission-efficiency acquirer 12 that acquires transmission efficiency information indicating a transmission efficiency of power transmitted from the power transmission device 10 to the power reception device 20; the user-operation acquirer that acquires hold information indicating whether or not the power reception device 20 is held by the user when the transmission efficiency information indicates that the transmission efficiency changed; and the power controller 14 that continues the power transmission performed by the power transmission device 10 when the hold information acquired by the user-operation acquirer indicates that the power reception device 20 is held by the user and that stops the power transmission performed by the power transmission device 10 when the hold information indicates that the power reception device 20 is not held the user, and some or all of the above-described members may be included in the power transmission device 10 or may be included in the power reception device 20.

This configuration also offers an advantage that is analogous to that in the above-described embodiment.

(Example of Protocol between Power Transmission Device and Power Reception Device)

FIG. 5 illustrates a communication protocol between the power transmission device 10 and the power reception device 20 in the power transmission system 1 illustrated in FIG. 1. As illustrated in FIG. 5, in order for the power transmission device 10 to detect the power reception device 20, the power transmission device 10 outputs low power at regular intervals.

Thereafter, when the power reception device 20 is placed on the power-transmission coil 15 in the power transmission device 10, the power reception device 20 sends the ID information of the power reception device 20 to the power transmission device 10.

Upon obtaining the ID information from the power reception device 20, the power transmission device 10 starts power control for power transmission and performs power transmission processing (charging).

When the power transmission device 10 determines that the transmission efficiency changes during the charging, the power transmission device 10 requests the power reception device 20 to transmit information indicating whether or not a user operation is performed on the power reception device 20. The power reception device 20 transmits the information indicating whether or not a user operation is performed to the power transmission device 10, and the power transmission device 10 determines whether the power transmission is to be continued or stopped.

According to an example of the communication protocol between the power transmission device 10 and the power reception device 20, since the information indicating whether or not the power reception device 20 is operated by the user is added to the communication protocol, it is possible to suppress power transmission stop caused by foreign-object false detection.

### [Implementation Example Using Software]

Control blocks in the power transmission device 10 and the power reception device 20 (particularly, the power controller 14 in the power transmission device 10) may be implemented by a logic circuit (hardware) formed in an integrated circuit (IC chip) or the like or may be implemented by software.

In the latter case, the power transmission device 10 and the power reception device 20 each include a computer that executes instructions from a program that is software for realizing individual functions. Each computer includes, for example, at least one processor (control device) and at least one computer-readable recording medium storing the program therein. In the computer, the processor reads the program from the recording medium and executes the program to thereby suppress power transmission stop caused by foreign act false detection or the like. The processor can be implemented for example, a central processing unit (CPU). The recording medium can be implemented by a non-transient tangible medium, such as a read-only memory (ROM), or a tape, a disc/disk, a card, a semiconductor memory, a programmable logic circuit, or the like. The computer may further include a random-access memory (RAM) or the like to which the above-described program is loaded. The program may also be transmitted to the computer over an arbitrary transmission medium (such as a communications network or a broadcast radio wave). One aspect of the present disclosure can also be realized in the form of data signals obtained by electronically transmitting the program over a carrier wave.

### [Brief Summary]

A power transmission device (10) according to a first aspect of the present disclosure includes: a power supply (11) that transmits power to a power reception device (20); a transmission-efficiency acquirer (12) that acquires transmission efficiency information indicating a transmission efficiency of the power transmitted to the power reception device (20); a communicator (13) that receives hold information indicating whether or not the power reception device (20) is held by a user from the power reception device (20), when the transmission efficiency information indicates that the transmission efficiency changed; and a power controller (14) that continues the power transmission performed by the power supply (11) when the hold information received by the communicator (13) indicates that the power reception device (20) is held by the user and that stops the power transmission performed by the power supply (11) when the hold information indicates that the power reception device (20) is not held by the user.

According to the above-described configuration, since the power controller (14) controls whether or not the power supply (11) is to perform the power transmission, based on the hold information, it is possible to suppress power transmission stop caused by a transmission efficiency change due to a cause other than the presence of a foreign object. In other words, according to the above-described configuration, it is possible to suppress power transmission stop due to foreign-object false detection or the like.

The power transmission device (10) according to a second aspect of the present disclosure may have a configuration in which, in the first aspect described above, when the transmission efficiency information indicates that the transmission efficiency changes, the communicator (13) transmits information for requesting the power reception device (20) to transmit the hold information indicating whether or not the power reception device (20) is held by the user.

According to the above-described configuration, the hold information indicating whether or not the power reception device (20) is held by the user can be reliably transmitted from the power reception device (20) to the power transmission device (10).

A power reception device (20) according to a third aspect of the present disclosure includes: a power receiver (21) that receives power transmitted from a power transmission device (10); a user-operation detector (22) that detects whether or not the power reception device (20) is held by a user when the power receiver (21) receives the power; and a communicator (23) that transmits, to the power transmission device (10), hold information indicating a result of the detection performed by the user-operation detector (22).

According to the above-described configuration, since the power reception device (20) includes the user-operation detector (22) that detects whether or not the power reception device (20) is held by the user when the power receiver (21) receives power, the hold information for the user can be transmitted to the power transmission device (10).

The power reception device (20) according to a fourth aspect of the present disclosure may further include, in the third aspect, a transmission-efficiency calculator (24) that calculates a transmission efficiency of the power transmitted from the power transmission device (10). When the transmission efficiency calculated by the transmission-efficiency calculator (24) changes, the communicator (23) may transmit transmission efficiency information indicating that the transmission efficiency changed to the power transmission device (10).

According to the above-described configuration, the power reception device (20) further includes the transmission-efficiency calculator (24) that calculates the transmission efficiency of the power transmitted from the power transmission device (10), and thus, when the transmission efficiency changes, the transmission efficiency information to that effect can be transmitted to the power transmission device (10).

A power transmission system (1) according to a fifth aspect of the present disclosure including a power transmission device (10) and a reception device (20). The power transmission system (1) includes: a transmission-efficiency acquirer (12) that acquires transmission efficiency information indicating a transmission efficiency of power transmitted from the power transmission device (10) to the power reception device (20); a user-operation acquirer that acquires hold information indicating whether or not the power reception device (20) is held by a user, when the transmission efficiency information indicates that the transmission efficiency changed; and a power controller (14) that continues the power transmission performed by the power transmission device (10) when the hold information acquired by the user-operation acquirer indicates that the power reception device (20) is held by the user and that stops the power transmission performed by the power transmission device (10) when the hold information indicates that the power reception device (20) is not held by the user.

The above-described configuration offers an advantage that is analogous to that of the first or third aspect.

A power transmission method according to a sixth aspect of the present disclosure includes: transmitting power to a power reception device (20); acquiring transmission efficiency information indicating a transmission efficiency of the power transmitted to the power reception device (20); receiving hold information indicating whether or not the power reception device (20) is held by a user from the power reception device (20), when the transmission efficiency information indicates that the transmission efficiency changed; and continuing the power transmission when the received hold information indicates that the power reception device (20) is held by the user and stopping the power transmission when the hold information indicates that the power reception device (20) is not held by the user.

The above-described configuration offers an advantage that is analogous to that of the first aspect.

A power reception method according to a seventh aspect of the present disclosure includes: receiving power transmitted from a power transmission device (10); detecting whether or not a power reception device (20) is held by a user when the power is received; and transmitting hold information indicating a result of the detection to the power transmission device (10).

The above configuration offers an advantage that is analogous to that of the third aspect.

The present disclosure is not limited to each embodiment described above, various changes are possible within the scope recited in the appended claims, and embodiments obtained by appropriately combining the technical means respectively disclosed in the different embodiments are also encompassed by the technical scope of the present disclosure. In addition, new technical features can be formed by combining the technical means respectively disclosed in the embodiments.

While there have been described what are at present considered to be certain embodiments of the invention, it will be understood that various modifications may be made thereto, and it is intended that the appended claims cover all such modifications as fail within the true spirit and scope of the invention.

The present disclosure contains subject matter related to that disclosed in Japanese Priority Patent Application JP 2019-206186 filed in the Japan Patent Office on Nov. 14, 2019, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A power transmission device comprising:
a power supply that transmits power to a power reception device;
a transmission-efficiency acquirer that acquires transmission efficiency information indicating a transmission efficiency of the power transmitted to the power reception device;
a communicator that receives hold information indicating whether or not the power reception device is held by a user from the power reception device, when the transmission efficiency information indicates that the transmission efficiency changed; and
a power controller that continues the power transmission performed by the power supply when the hold information received by the communicator indicates that the power reception device is held by the user and that stops the power transmission performed by the power supply when the hold information indicates that the power reception. device is not held by the user.

2. The power transmission device according to claim 1, wherein the communicator
transmits information that requests the power reception device to transmit hold information indicating whether or not the power reception device is held by the user, when the transmission efficiency information indicates that the transmission efficiency changed.

3. A power reception device comprising:
a power receiver that receives power transmitted from a power transmission device;
a user-operation detector that detects whether or not the power reception device is held by a user when the power receiver receives the power; and
a communicator that transmits, to the power transmission device, hold information indicating a result of the detection performed by the user-operation detector.

4. The power reception device according to claim 3, further comprising:
a transmission-efficiency calculator that calculates a transmission efficiency of the power transmitted from the power transmission device,
wherein, when the transmission efficiency calculated by the transmission-efficiency calculator changes, the communicator transmits transmission efficiency information indicating that the transmission efficiency changed to the power transmission device.

5. A power transmission system including a power transmission device and a power reception device, the power transmission system comprising;
a transmission-efficiency acquirer that acquires transmission efficiency information indicating a transmission efficiency of power transmitted from the power transmission device to the power reception device;
a user-operation acquirer that acquires hold information indicating whether or not the power reception device is held by a user, when the transmission efficiency information indicates that the transmission efficiency changed; and
a power controller that continues the power transmission performed by the power transmission device when the hold information acquired by the user-operation acquirer indicates that the power reception device is held by the user and that stops the power transmission performed by the power transmission device when the hold information indicates that the power reception device is not held by the user.

6. A power transmission method
transmitting power to a power reception device;
acquiring transmission efficiency information indicating a transmission efficiency of the power transmitted to the power reception device;
receiving hold information indicating whether or not the power reception device is held by a user from the power reception device, when the transmission efficiency information indicates that the transmission efficiency changed; and
continuing the power transmission when the received hold information indicates that the power reception device is held by the user and stopping the power transmission when the hold information indicates that the power reception device is not held by the user.

7. A power reception method comprising:
receiving power transmitted from a power transmission device;
detecting whether or not the power reception device is held by a user when the power is received; and
transmitting hold information indicating a result of the detection to the power transmission device.

8. A computer-readable non-transitory recording medium recording therein a power transmission program for causing a computer to function as the power transmission device according to claim 1,
wherein the power transmission program causes the computer to function as the power supply, the transmission-efficiency acquirer, the communicator, and the power controller.

9. A computer-readable non-transitory recording medium recording therein a power reception program for causing a computer to function as the power reception device according claim 3,
wherein the power reception program causes the computer to function as the power receiver, the user-operation detector, and the communicator.
